(19) United States
(12) Patent Application Publication
(10) Pub. No.: US 2016/0291953 A1
(43) Pub. Date: Oct. 6, 2016

(54) MODULAR PDF APPLICATION

(71) Applicant: LULU SOFTWARE LIMITED, Montreal (CA)

(72) Inventors: Igor TUZLUKOV, Liubotyn (UA); Valeriy DUBOK, Kharkiv (UA); Anatoliy LYSENKO, Montreal (CA); Eric GAREAU, Repentigny (CA)

(73) Assignee: Lulu Software Limited, Quebec (CA)

(21) Appl. No.: 15/036,232

(22) PCT Filed: Nov. 12, 2014
(86) PCT No.: PCT/CA2014/000815

§ 371 Date: May 12, 2016

Related U.S. Application Data
(60) Provisional application No. 61/903,111, filed on Nov. 12, 2013.

(51) Int. Cl. G06F 9/445; G06F 21/62

(52) U.S. Cl. CPC G06F 8/61; G06F 8/62; G06F 21/629

(57) ABSTRACT

A modular PDF application which allows users to customize their own PDF versions by choosing the features that they need and/or can pay for, thus, reducing the price of such PDF license and an overall footprint of such PDF version on the computer. The PDF application comprises a main application which includes the reader and a variety of optional features that the user may chose from and add to the main application before during or after installing the main application. The main application comprises business logic for running the viewer module and for receiving and running the optional features. The business logic includes inter-dependability rules and functions between the different features to ensure an optimum operability of the installed features in the presence or absence of the other features that they depend on.

### BACKGROUND

(a) Field

The subject matter disclosed generally relates to a PDF application.

(b) Related Prior Art

PDF (Portable Document Format) is a file format used to present documents in a manner independent of application software, hardware, and operating systems. PDF is the de facto standard for fixed-format electronic documents.

Existing PDF applications come with too many options and features that the client ends up paying for and not using. In addition to the costs, these programs when running heavily consume the available computing resources: CPU time, RAM, disk space, bandwidth etc.

In particular, existing PDF applications come in an integral form whereby a user has to buy and download the full version of an application i.e. all the features integrated in a given PDF Application. Typically the basic version of such applications requires 80 MB of memory to install and around 300 MB when it is deployed. The costs for each license are very cost-prohibitive for students and other organisations.

Most users use these PDF applications for transforming their documents from editable versions into PDF. Some others use the OCR option (optic character recognition) to extract the text from a PDF document such e.g. a scanned page or the like. However, these options constitute only a small fraction of what is installed, running, and paid for in the full versions of the existing PDF Applications.

Therefore, there is a need in the market for a PDF application which addresses the above limitations.

### SUMMARY

The present embodiments describe such application.

In an embodiment, a PDF application is provided which allows users to customize their own PDF application and choose features in accordance with their budgets and needs. The features are provided as a set of application packages which may be downloaded and installed separately/individually but they work as a sole unit with the main application receiving them (e.g. as a single program or within the same interface of the main application). The features are also uninstalled individually without requiring un-installation of the main application or other features and without affecting the working of the other features that remain installed within the main application even if the installed features depend on the un-installed features.

In an aspect, there is provided a memory having recorded thereon non-transitory computer readable statements and instructions which when executed by a processor of a computing device cause the processor to implement a modular PDF application comprising: a main application comprising a viewer module; a plurality of optional modules; wherein the main application comprises business logic for running the viewer module and business logic for running each one of the plurality of optional modules; and wherein upon receiving a user-input to install a selected optional module the selected optional module is installed within the main application and run as a sole working unit with the main application.

In an embodiment, at least a first optional module is dependent on a second optional module, wherein the main application comprises inter-dependability rules and functions for running the first optional module irrespective of a presence or an absence of the second optional module from the main application.

The main application and the optional modules may be provided as separate installation packages. The installation packages may be provided as (*.msi) files. Each installation package may comprise a dynamic library-plug including executable files, Windows Registry® scripts, and custom actions required for executing an associated module.

The main application may contain resources required for executing the viewer module and each one of the plurality of optional modules, irrespective of the presence or absence of a given module on which the selected module depends.

Upon receiving another user-input to uninstall a previously installed optional module the previously installed optional module is un-installed from the main application without affecting an operation of any other optional module that remains installed within the main application.

In an embodiment, the main application may be configured to receive and run authorized third party applications. The main application may be secured with a digital signature for preventing unauthorized third party modules from being installed within the main application.

In another aspect there is provided a memory having recorded thereon non-transitory computer readable statements and instructions which when executed by a processor of a computing device cause the processor to implement a modular PDF application comprising: a main application comprising a viewer module; a plurality of optional modules; wherein the main application comprises business logic for running the viewer module and business logic for running each one of the plurality of optional modules, the business logic comprising inter-dependability rules and functions for running any selected optional module irrespective of a presence or an absence of another optional module on which the selected optional module depends, from the main application.

In a further aspect, there is provided a computing device comprising: a processor; a memory comprising one or more programs for execution by the processor for implementing a modular PDF application comprising: a main application comprising a viewer module; a plurality of optional modules; wherein the main application comprises business logic for running the viewer module and business logic for receiving and running each one of the plurality of optional modules, the business logic comprising inter-dependability rules and functions for running any selected optional module irrespective of a presence or an absence of another optional module on which the selected optional module depends, from the main application.

According to yet a further aspect, there is provided a memory having recorded thereon computer readable instructions for implementing a modular PDF application, said instructions when executed by a processor cause the processor to perform the steps of: installing a main application comprising a viewer module, business logic for the viewer module and business logic for receiving and running a plurality of available features; receiving a user-input selecting one or more of the plurality of available features; embedding the at least one selected feature within the main application, such that the selected feature is run as part of the main application after the embedding.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIGS. 1a to 1f illustrates exemplary snapshots of the installation interface of a modular PDF Application at different installation steps, in accordance with an embodiment;

FIG. 2 illustrates a snapshot of a modular PDF Application after the installation and shows how the selected features are available within the main application, in accordance with an embodiment;

FIG. 3a is a block diagram illustrating the algorithm on embedded modules management and the different features that may be injected therein, in accordance with an embodiment;

FIG. 3b is a block diagram illustrating the algorithm on embedded modules management including features that have been selected and installed, and the remaining features that are available to be added, in accordance with an embodiment; and

FIG. 4 illustrates a generalized example of a suitable computing environment 600 in which the described embodiments may be implemented.

It will be noted that throughout the appended drawings, like features are identified by like reference numerals.

### DETAILED DESCRIPTION

In an embodiment, there is described a modular PDF application which allows users to customize their own PDF version by choosing the features that they need and/or can pay for, thus, reducing the price of such PDF license and an overall footprint of such PDF version on the computer. The modular PDF application allows the user to add further features and remove unwanted/un-used features. The PDF application comprises a main application which includes the reader/viewer and a variety of optional features that the user may chose from and add to the main application during or after installing the main application. When installed, the optional features are run within the core of the main application and in the same interface as the latter such that the main application and the optional features would run a single working unit. The main application comprises business logic including inter-dependability rules and functions between the different features to ensure an optimum operability of the installed features in the presence or absence of the other features that they depend on.

In an embodiment, the modular PDF application, when deployed, comprises a main application which provides for a base/platform for all the available features to run. In an embodiment, the main application includes the algorithms on embedded modules management, a viewer module, the business logic for the viewer module, and all necessary business logic to receive and run the other available features. Once the main application is installed, the other features may be added, whereby, the user may make a selection of programs and install them. Once selected, these features are added/installed within the main application to be embedded therein and become part of the overall functionality of the application.

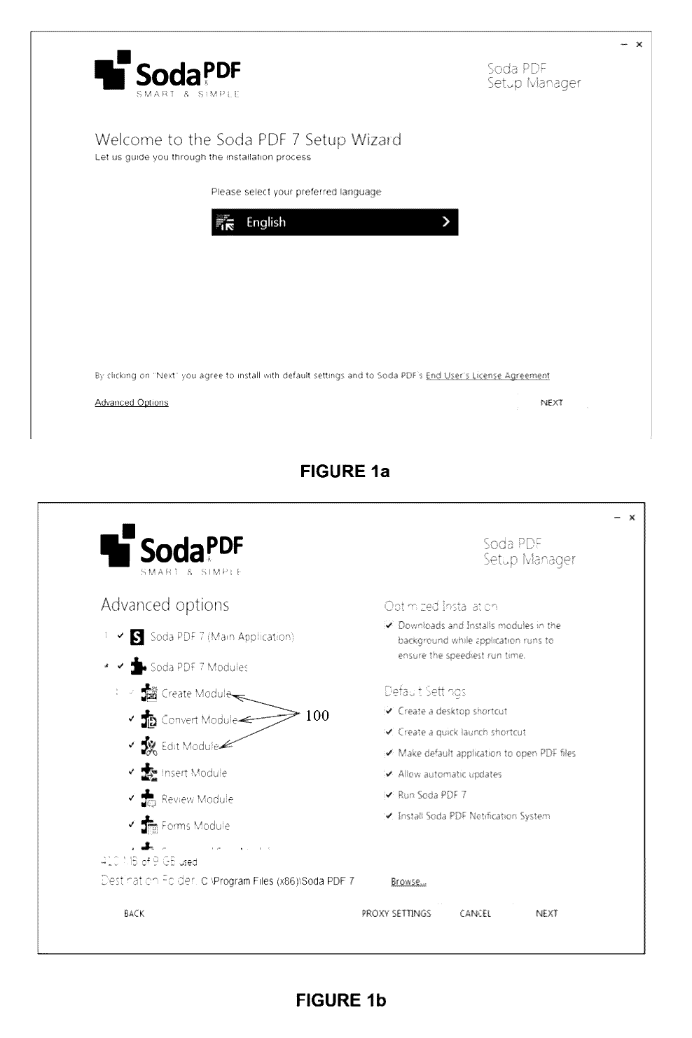

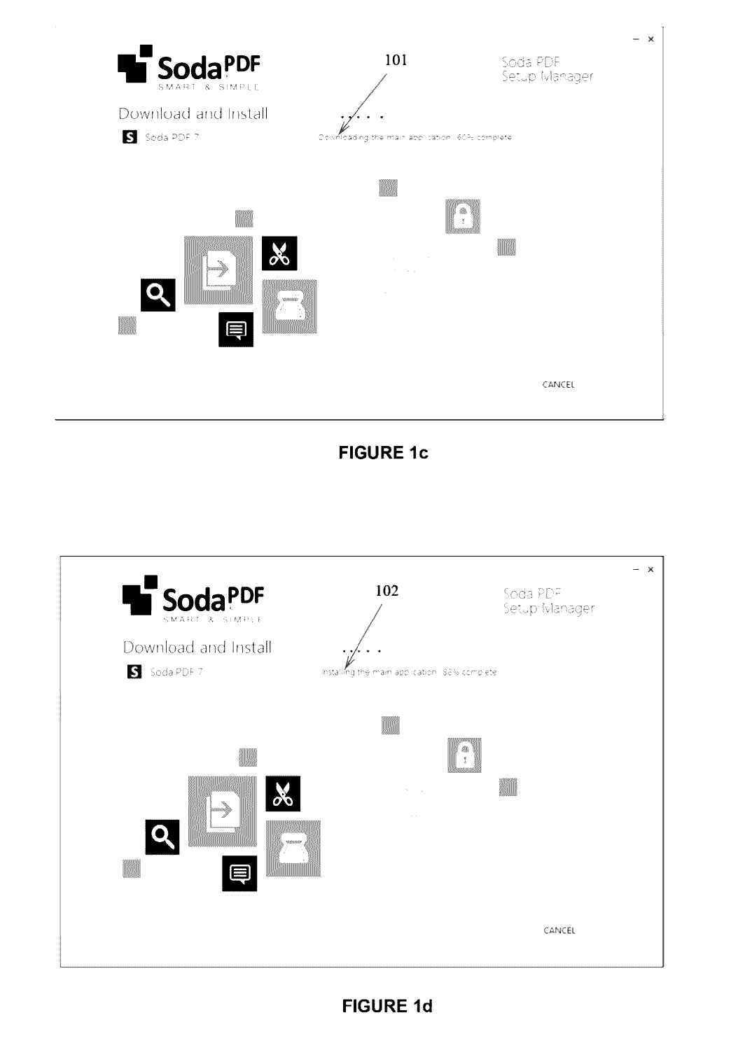

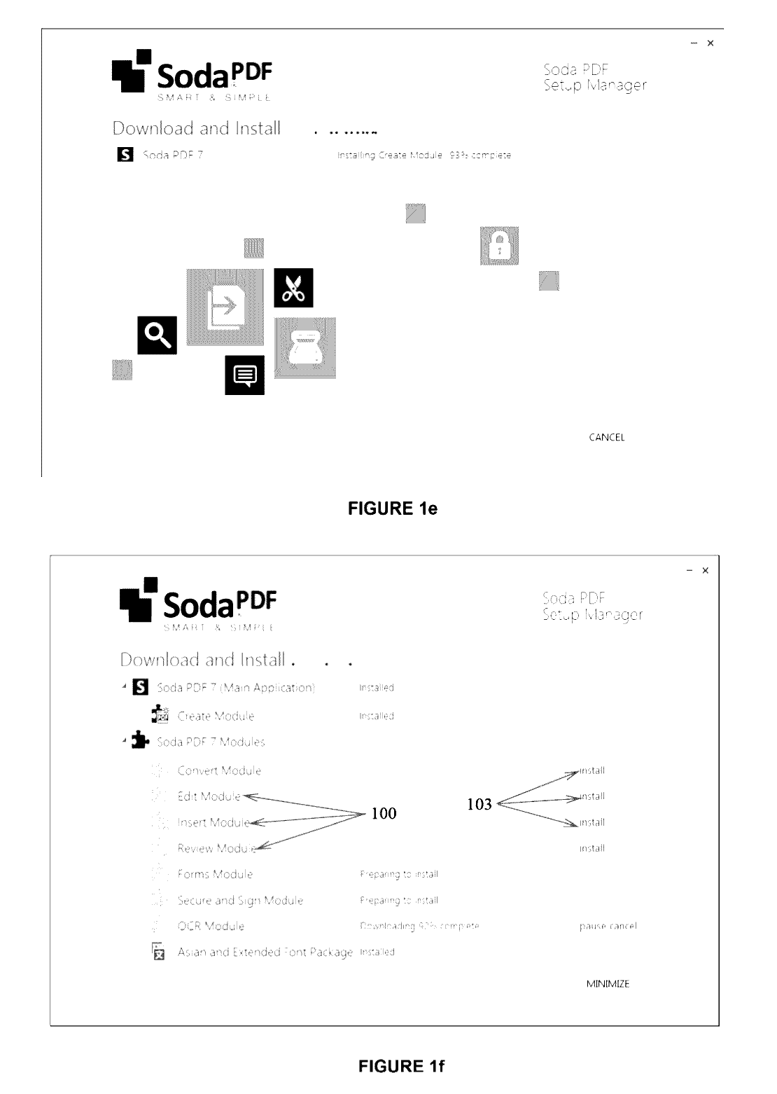

FIGS. 1a to 1f illustrate exemplary snapshots of the installation interface of a modular PDF Application at different installation steps, in accordance with an embodiment. As shown in FIGS. 1a to 1f, the modular PDF application is referred to as “Soda PDF”. As shown in FIG. 1a, a user may be prompted to select a language.

Once the preferred language is selected, users can customize Soda PDF by clicking the Advanced Options link and selecting the features appropriate to their needs. FIG. 1b illustrates a list of available features 100, in accordance with an embodiment. The Create Module (default feature) is intended for creating a PDF document. The Convert Module may be selected if a user wants to convert a document from another format into PDF. The Edit Module for editing an existing PDF document. The Insert Module for inserting text or objects within a PDF document. The Review Module for creating and editing annotations such as: comments, stamps, shapes, markups etc. The Forms Module for creating and editing PDF forms within PDF documents. The Secure and Sign Module for securing a document and locking it to prevent further editing/modification. The OCR Module for recognizing text/characters in a PDF document. The Asian and Extended Font Package for displaying the documents with Asian encoded characters and several other foreign character sets in a correct way.

On selecting desired features, the main application is being downloaded and installed automatically as illustrated at 101 in FIG. 1c and 102 in FIG. 1d respectively. Afterwards, the selected features are being installed one by one as displayed in FIG. 1e. To ensure the speediest run time the Soda PDF Setup Manager may install other preselected features, if any, in the background mode. A user can view a set of features being installed by clicking the Soda PDF icon in the tray as displayed in FIG. 1f. Besides, FIG. 1f illustrates all the available features 100 available for installation.

The user may choose one or more of these features 100 to install by pressing the corresponding install button 103. As shown in FIG. 1f, the user may pause/cancel the installation of a given feature 100, e.g. the OCR Module, and/or add a further feature 100 to the viewer module, e.g., the Secure and Sign module.

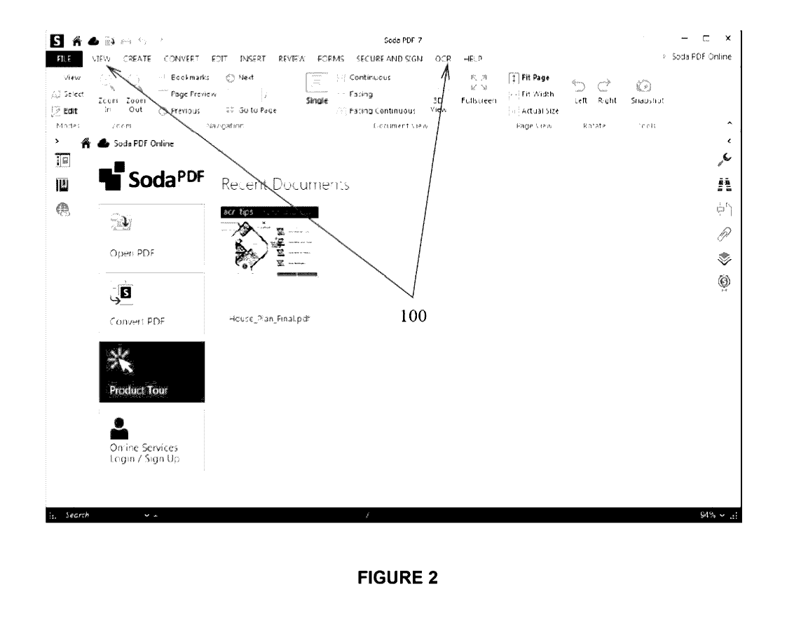

When a user is done selecting and installing features 100, the installation process finishes and the selected features will appear in the main application as illustrated with reference to FIG. 2. FIG. 2 illustrates a snapshot of a modular PDF Application after the installation and shows how the selected features are available within the main application, in accordance with an embodiment. In case a feature is not installed, a user is prompted to download and install it.

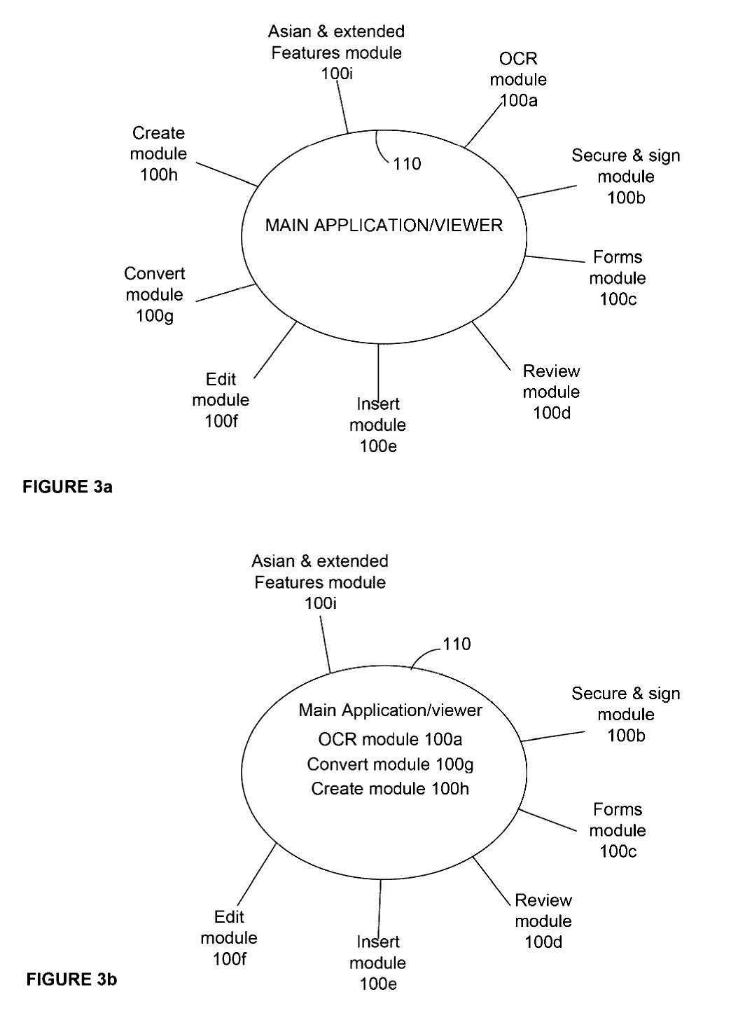

FIG. 3a is a block diagram illustrating the main application and the different features that may be added therein, in accordance with an embodiment. As discussed above, when the viewer module 110 is installed, the user may choose one or more features 100 to add therein. Once selected and run, these features are embedded within the main application 110 to become part of the overall functionality of the main application 110. In other words, the main application 110 acts as an engine to provide the necessary business logic for each feature 100 to be received and installed within. FIG. 3b is a block diagram illustrating the main application including features that have been selected and installed, and the remaining features that are available to be added, in accordance with an embodiment.

In an embodiment, the business logic included in the main application includes inter-dependability rules and functions between the different features to ensure an optimum operability of the installed features in the presence or absence of the other features they depend on. Whereby additional features may be added and unwanted features can be removed in a plug and play manner without having to re-install the entire program as is the case now with conventional PDF applications which require the un-installing of the previous versions of the program to re-install the new ones or the full ones. In other words, if a first optional module depends on a second optional module and the user chooses to install only the first module, the main application may still install and run the first module in an optimal manner without requiring the user to pay for and install the second module and this is due to the inter-dependability rules included in the business logic of the main application.

In a further embodiment, it is possible, using the configuration discussed above, to receive and to implement third party features as long as they are conform with the specifications and requisitions of the modular PDF application. For example, if a third party develops a feature or program that may be added to the existing features 100, the third party feature may be tested and added to the list for the users to select and install, thus making the main application as a platform for receiving third party applications and add-ons.

In an embodiment, the modular PDF application may be provided as a set of installation packages. Every installation package represents a different module 100 and includes the necessary resources required to ensure proper execution of that module 100. The installation package for the main module 110 differs from the other installation packages of the other modules 100 in that it contains the resources necessary for executing the main module 110 and also the other modules 100. Accordingly, the modules 100 may be created as a set of mini-applications that may be added to the main application 110 to supply the main application with a variety of features as needed and as selected by the user. In an embodiment, every module 100 comprises a special dynamic library-plugin (.dll) which contains information on how that module 100 is embedded into the main module 110.

In an embodiment, when starting the host process of the main module (*.exe), the plug-in subsystem and its main component are automatically initialized. The plug-in subsystem component loads the above-mentioned plug-in (.dll) of the different modules 100 to the host process. The library-plugin (.dll) loads resources and code required for executing the module 100, and also adjusts the main module 110 so that it meets the requirements of the module 100. In an embodiment the library-plugin (.dll) of the main module 110 may be secured with a digital signature to preventing unauthorized modules from embedding into the host process.

In a non-limiting example of implementation, the installation packages may be deployed using the MSI®-technology of Microsoft Windows®, whereby every installation package may be provided as an *.msi file including executable files, Windows Registry scripts, custom actions and other resources required to ensure proper execution of a particular module 100. To ensure proper operation of the installation packages in the manner discussed above (to add and remove packages without having to reinstall the entire application) the installation packages of the different modules 100 need to be installed within the same directory (windows dir), as the main module 110. The main application scripts and the Windows® registry scripts may also be added to the same hive.

### Hardware and Computing Environment

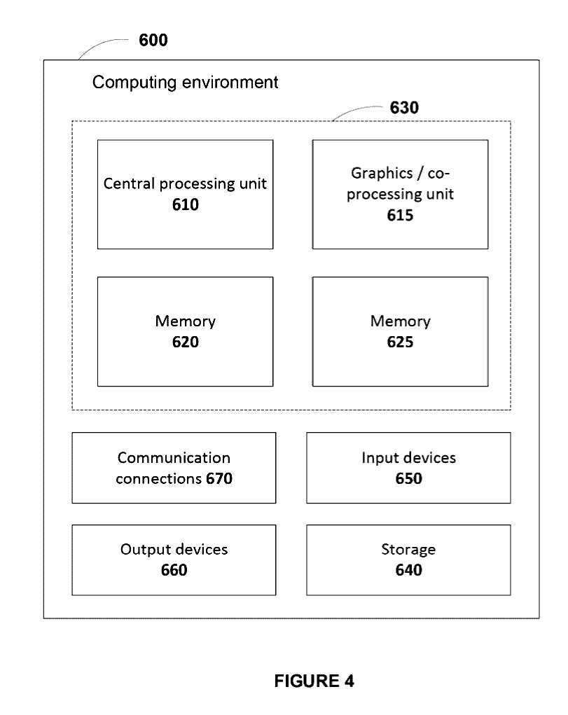

FIG. 4 illustrates a generalized example of a suitable computing environment 600 in which the described embodiments may be implemented. The computing environment 600) is not intended to suggest any limitation as to scope of use or functionality, as the techniques and tools may be implemented in diverse general-purpose or special-purpose computing environments.

With reference to FIG. 4, the computing environment 600 includes at least one CPU 610 and associated memory 620 as well as at least one GPU or other co-processing unit 615 and associated memory 625 (used for example for video acceleration). In FIG. 4, this most basic configuration 630 is included within a dashed line. The processing unit 610 executes computer-executable instructions and may be a real or a virtual processor. In a multi-processing system, multiple processing units execute computer-executable instructions to increase processing power. A host encoder or decoder process offloads certain computationally intensive operations to the GPU 615. The memory 620,125 may be volatile memory (e.g., registers, cache, RAM), non-volatile memory (e.g., ROM, EEPROM, flash memory, etc.), or some combination of the two. The memory (620, 625) stores software 680 for a decoder implementing one or more of the decoder innovations described herein.

A computing environment may have additional features. For example, the computing environment 600 includes storage 640, one or more input devices 650, one or more output devices 660, and one or more communication connections 670. An interconnection mechanism (not shown) such as a bus, controller, or network interconnects the components of the computing environment 600. Typically, operating system software (not shown) provides an operating environment for other software executing in the computing environment 600, and coordinates activities of the components of the computing environment 600.

The storage 640 may be removable or non-removable, and includes magnetic disks, magnetic tapes or cassettes, CD-ROMs, DVDs, or any other medium which can be used to store information and which can be accessed within the computing environment 600. The storage 640 stores instructions for the software 680.

The input device(s) 650 may be a touch input device such as a keyboard, mouse, pen, or trackball, a voice input device, a scanning device, or another device that provides input to the computing environment 600. For audio or video encoding, the input device(s) 650 may be a sound card, video card, TV tuner card, or similar device that accepts audio or video input in analog or digital form, or a CD-ROM or CD-RW that reads audio or video samples into the computing environment 600. The output device(s) 660 may be a display, printer, speaker, CD-writer, or another device that provides output from the computing environment 600.

The communication connection(s) 670 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The techniques and tools can be described in the general context of computer-readable media. Computer-readable media are any available media that can be accessed within a computing environment. By way of example, and not limitation, with the computing environment 600, computer readable media include memory 620, storage 640, communication media, and combinations of any of the above.

The techniques and tools can be described in the general context of computer-executable instructions, such as those included in program modules, being executed in a computing environment on a target real or virtual processor. Generally, program modules include routines, programs, libraries, objects, classes, components, data structures, etc., that perform particular tasks or implement particular abstract data types. The functionality of the program modules may be combined or split between program modules as desired in various embodiments. Computer-executable instructions for program modules may be executed within a local or distributed computing environment.

For the sake of presentation, the detailed description may use terms like “decide,” “make” and “get” to describe computer operations in a computing environment. These terms are high-level abstractions for operations performed by a computer, and should not be confused with acts performed by a human being. The actual computer operations corresponding to these terms vary depending on implementation.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A memory having recorded thereon non-transitory computer readable statements and instructions which when executed by a processor of a computing device cause the processor to implement a modular PDF application comprising:
a main application comprising a viewer module;
a plurality of optional modules;
wherein the main application comprises business logic for running the viewer module and business logic for running each one of the plurality of optional modules; and
wherein upon receiving a user-input to install a selected optional module the selected optional module is installed within the main application and run as a sole working unit with the main application.

2. The memory of claim 1, wherein at least a first optional module is dependent on a second optional module, and wherein the main application comprises inter-dependability rules and functions for running the first optional module irrespective of a presence or an absence of the second optional module from the main application.

3. The memory of claim 1, wherein the main application and the optional modules are provided as separate installation packages.

4. The memory of claim 3, wherein each installation package comprises a dynamic library-plug including executable files, Windows Registry® scripts, and custom actions required for executing an associated module.

5. The memory of claim 4, wherein the main application contains resources required for executing the viewer module and each one of the plurality of optional modules, irrespective of the presence or absence of a given module on which the selected module depends.

6. The memory of claim 4, wherein scripts of the main application and scripts of the Windows Registry® are added in a single hive.

7. The memory of claim 3, wherein the installation packages are provided as (*.msi) files.

8. The memory of claim 3, wherein the installation packages of the optional modules are installed within the same directory as the installation package of the main application.

9. The memory of claim 1, wherein upon receiving another user-input to uninstall a previously installed optional module the previously installed optional module is un-installed from the main application without affecting an operation of any other optional module that remains installed within the main application.

10. The memory of claim 1, wherein the main application is configured to receive and run authorized third party applications.

11. The memory of claim 10, wherein the main application is secured with a digital signature for preventing unauthorized third party modules from being installed within the main application.

12. A memory having recorded thereon non-transitory computer readable statements and instructions which when executed by a processor of a computing device cause the processor to implement a modular PDF application comprising:
a main application comprising a viewer module;
a plurality of optional modules;
wherein the main application comprises business logic for running the viewer module and business logic for running each one of the plurality of optional modules, the business logic comprising inter-dependability rules and functions for running any selected optional module irrespective of a presence or an absence of another optional module on which the selected optional module depends, from the main application.

13. A computing device comprising:
a processor;
a memory comprising one or more programs for execution by the processor for implementing a modular PDF application comprising:
a main application comprising a viewer module;
a plurality of optional modules;
wherein the main application comprises business logic for running the viewer module and business logic for receiving and running each one of the plurality of optional modules, the business logic comprising inter-dependability rules and functions for running any selected optional module irrespective of a presence or an absence of another optional module on which the selected optional module depends, from the main application.

14. The computing device of claim 13, wherein the main application and the optional modules are provided as separate installation packages, each installation package comprises a dynamic library-plug including executable files, Windows Registry® scripts, and custom actions required for executing an associated module.

15. The computing device of claim 13, wherein the main application and the optional modules are provided as separate installation packages.

16. The computing device of claim 14, wherein the installation packages are provided as (*.msi) files.

17. The computing device of claim 14, wherein the installation packages of the optional modules are installed within the same directory as the installation package of the main application.

18. The computing device of claim 13, wherein upon receiving a user-input to uninstall a previously installed optional module the previously installed optional module is un-installed from the main application without affecting an operation of any other optional module that remains installed within the main application.

19. The computing device of claim 13, wherein the main application is configured to receive and run authorized third party applications.

20. The computing device of claim 19, wherein the main application is secured with a digital signature for preventing unauthorized third party modules from being installed within the main application.
